(19) United States
(12) Patent Application Publication
(10) Pub. No.: US 2023/0196073 A1
(43) Pub. Date: Jun. 22, 2023

(54) METHOD FOR SECURE USE OF A FIRST NEURAL NETWORK ON AN INPUT DATUM AND METHOD FOR LEARNING PARAMETERS OF A SECOND NEURAL NETWORK

(71) Applicant: IDEMIA IDENTITY & SECURITY FRANCE, Courbevoie (FR)

(72) Inventors: Hervé CHABANNE, Courbevoie (FR); Linda GUIGA, Courbevoie (FR)

(73) Assignee: IDEMIA IDENTITY & SECURITY FRANCE, Courbevoie (FR)

(21) Appl. No.: 17/999,155

(22) PCT Filed: May 14, 2021
(86) PCT No.: PCT/FR2021/050842

§ 371 Date: Nov. 17, 2022

(30) Foreign Application Priority Data
May 18, 2020 (FR) 2004945

(51) Int. Cl. G06N 3/045; G06N 3/0985

(52) U.S. Cl. CPC G06N 3/045; G06N 3/0985

(57) ABSTRACT

A method for secure use of a first neural network on an input datum, the method comprising implementing, by data processing circuitry of a terminal: (a) constructing a second neural network which corresponds to the first neural network and receives at least one convolutional neural network approximating the identity function, (b) using the second neural network on the input datum. Further including a method for training parameters of the second neural network.

### GENERAL TECHNICAL FIELD

The present invention relates to the field of artificial intelligence, and in particular to a method for the secure use of a first neural network on an input datum.

### PRIOR ART

Neural networks (or NN) are widely used for data classification.

After a phase of machine learning (which is generally supervised, that is to say on a reference database of already classified data), a neural network “learns” and becomes capable of applying the same classification to unknown data on its own. More precisely, the value of weights and parameters of the NN is progressively modified until it is capable of implementing the targeted task.

Significant progress has been made in recent years, both on the architectures of neural networks and on learning techniques (in particular in deep learning) or even on the learning bases (size and quality thereof), and tasks previously considered impossible are nowadays performed by neural networks with excellent reliability.

All this means that high-performance neural networks and their learning bases nowadays have a high commercial value and are treated as “trade secrets” to be protected. In addition, many databases contain potentially personal data (for example fingerprints) that have to be kept confidential.

Unfortunately, “reverse engineering” techniques have been developed in recent times, allowing an attacker to extract the parameters and the model of any neural network provided that it is possible to submit enough well-chosen requests thereto, as described in the document Cryptanalytic Extraction of Neural Network Models, Nicholas Carlini, Matthew Jagielski, Ilya Mironov https://arxiv.org/pdf/2003.04884v1.pdf. Thus, even in “black box” operation, in which there would be access only to the inputs and to the outputs (for example via a web client), the inside of the network could be recovered.

The idea is that of observing that a neural network contains an alternation of linear layers and non-linear layers implementing an activation function, such as ReLU. This non-linearity leads to “critical points” with a jump in the gradient, and it is thus possible to geometrically define, for each neuron, a hyperplane of the input space of the network, such that the output is at a critical point. The hyperplanes of the second layer are “folded” by the hyperplanes of the first layer, and so on.

The attacker may use exploration to recover the intersections of the hyperplanes and, progressively, the entire neural network.

An additional challenge encountered by neural networks is the existence of “antagonistic disturbances”, that is to say imperceptible changes that, when applied to an input of the neural network, change the output significantly. The document A Simple Explanation for the Existence of Adversarial Examples with Small Hamming Distance by Adi Shamir, Itay Safran, Eyal Ronen, and Orr Dunkelman, https://arxiv.org/pdf/1901.10861v1.pdf discloses for example how an antagonistic disturbance applied to an image of a cat may lead to it being misclassified as an image of guacamole.

More precisely, once an attacker has succeeded in identifying the division into hyperplanes explained above, he is able to determine a vector that makes it possible, from a point in the input space, to cross a hyperplane and therefore to modify the output.

It is therefore understood that it is essential to succeed in securing neural networks.

A first approach is that of increasing the size, the number of layers and the number of parameters of the network so as to complicate the task for the attacker. If this works, all this does is slow down the attacker, on the one hand, and above all this worsens performance as the neural network is then unnecessarily cumbersome and difficult to train.

A second approach is that of limiting the number of inputs able to be submitted to the neural network, or at least of detecting suspicious sequences of inputs. However, this is not always applicable, since the attacker may legally have access to the neural network, for example having paid for unrestricted access.

The situation could thus be further improved.

### PRESENTATION OF THE INVENTION

According to a first aspect, the present invention relates to a method for the secure use of a first neural network on an input datum, the method being characterized in that it comprises the implementation, by data processing means of a terminal, of the following steps:
(a) constructing a second neural network corresponding to the first neural network, into which is inserted at least one convolutional neural network approximating the identity function;
(b) using the second neural network on said input datum.

According to other advantageous and non-limiting features:

Said convolutional neural network is inserted at the input of a target layer of the first neural network.

Said target layer is a layer within the first neural network.

Said convolutional neural network has an output size smaller than an input size of said target layer so as to approximate only certain input channels of this target layer.

Step (a) comprises selecting said target layer of the first neural network from among the layers of said first neural network.

Step (a) comprises selecting the input channels of said target layer to be approximated from among all of the input channels of the target layer.

The at least one convolutional neural network approximating the identity function has an output size equal to the product of two integers.

The method comprises a preliminary step (a0) of obtaining parameters of the first neural network and of the at least one convolutional neural network approximating the identity function.

Step (a0) comprises obtaining parameters of a set of convolutional neural networks approximating the identity function.

Step (a) comprises selecting, from said set, at least one convolutional neural network approximating the identity function to be inserted.

Step (a) comprises, for each selected convolutional neural network approximating the identity function, said selecting of said target layer of the first neural network from among the layers of said first neural network and/or selecting the input channels of said target layer to be approximated from among all of the input channels of the target layer.

Step (a) furthermore comprises selecting, beforehand, a number of convolutional neural networks approximating the identity function of said set to be selected.

Step (a0) is a step, implemented by data processing means of a server, of learning the parameters of the first neural network and of the at least one convolutional neural network approximating the identity function from at least one learning database.

The first neural network and the one or more convolutional neural networks approximating the identity function comprise an alternation of linear layers and of non-linear layers with an activation function.

Said activation function is the ReLU function.

Said target layer is a linear layer of the first neural network.

The at least one convolutional neural network approximating the identity function comprises two or three linear layers.

The linear layers of the convolutional neural network are filter convolution layers, for example of a size 5×5.

According to a second aspect, what is proposed is a method for learning parameters of a second neural network, the method being characterized in that it comprises the implementation, by data processing means of a server, of the following steps:
(a) constructing the second neural network corresponding to a first neural network, into which is inserted at least one convolutional neural network approximating the identity function;
(a1) learning the parameters of the second neural network from a learning database.

According to a third aspect, what is proposed is a method for the secure use of a first neural network on an input datum, the method comprising learning parameters of a second neural network in accordance with the method according to the second aspect; and the implementation, by data processing means of a terminal, of a step (b) of using the second neural network on said input datum.

According to a fourth and a fifth aspect, the invention relates to a computer program product comprising code instructions for executing a method according to the first or third aspect for the secure use of a first neural network on an input datum, or according to the second aspect for learning parameters of a second neural network; and a storage means able to be read by a computer equipment on which a computer program product comprises code instructions for executing a method according to the first or the third aspect for the secure use of a first neural network on an input datum, or according to the second aspect for learning parameters of a second neural network.

### PRESENTATION OF THE FIGURES

Other features and advantages of the present invention will become apparent on reading the following description of one preferred embodiment. This description will be given with reference to the appended drawings, in which:

FIG. 1 is a diagram of an architecture for implementing the methods according to the invention;

FIG. 2a schematically shows the steps of a first embodiment of a method for the secure use of a first neural network on an input datum according to the invention;

FIG. 2b schematically shows the steps of a second embodiment of a method for the secure use of a first neural network on an input datum according to the invention;

FIG. 3 schematically shows one example of an architecture of a second neural network encountered in the implementation of the methods according to the invention.

### DETAILED DESCRIPTION

### Architecture

According to two complementary aspects of the invention, what are proposed are:
a method for the secure use of a first neural network (1^{st} NN)
a method for learning parameters of a second neural network (2^{nd} NN).

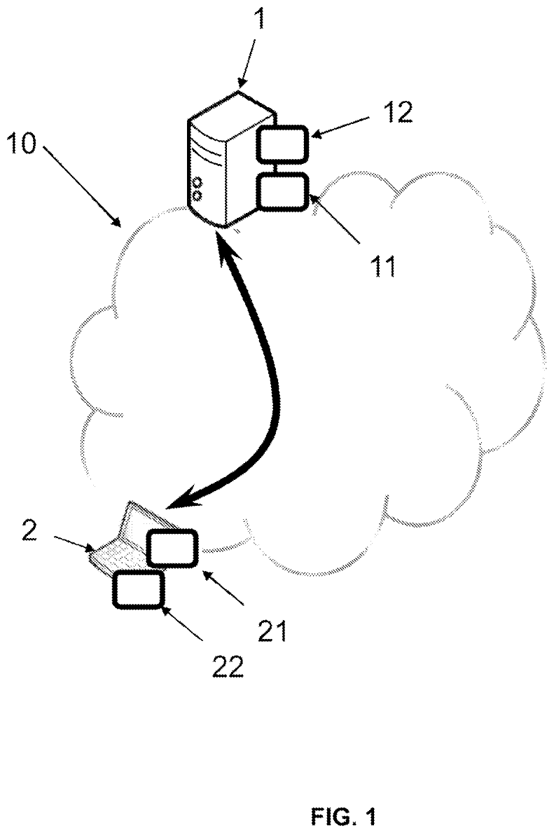

These two types of method are implemented within an architecture as shown by [FIG. 1], by virtue of at least one server 1 and one terminal 2. The server 1 is the learning equipment (implementing the second method) and the terminal 2 is a user equipment (implementing the first method). Said use method is implemented on an input datum, and is for example a classification of the input datum from among multiple classes if it is a classification NN (but this task is not necessarily a classification, even though this is the most conventional).

A limit will not be drawn to any type of NN in particular, even though this typically involves an alternation of linear layers and non-linear layers with a ReLU (Rectified Linear Unit) activation function, which is equal to σ(x)=max(0, x). It will therefore be understood that each hyperplane corresponds to the set of points of the input space such that an output of a linear layer is equal to zero. “ReLU NN” will be used to denote such a neural network.

In any case, each equipment 1, 2 is typically a remote computer equipment connected to a wide area network 10 such as the Internet in order to exchange data. Each one comprises data processing means 11, 21 of processor type, and data storage means 12, 22 such as a computer memory, for example a hard disk.

The server 1 stores a learning database, that is to say a set of data for which the associated output is already known, of data that are for example already classified (as opposed to what are known as the input data that it is precisely desired to process). This may be a learning base with high commercial value that it is sought to keep secret.

It will be understood that it is still possible for the equipments 1 and 2 to be the same equipment, or the learning base may even be a public base.

It should be noted that the present method is not limited to one type of NN and therefore not to one particular kind of data, and the input data or learning data may be representative of images, sounds, etc. The 1^{st} NN may very well be a CNN, even though a specialized CNN that will be used in the context of the present method will be described below.

In one preferred embodiment, biometric data are involved, the input data or learning data typically being representative of images or even directly images of biometric features (faces, fingerprints, irises, etc.), or directly pre-processed data resulting from the biometric features (for example the position of minutiae in the case of fingerprints).

### Principle

The present invention proposes to complicate the task for attackers without complicating the NN using artificial hyperplanes. In other words, the NN is made secure by making it significantly more robust, without otherwise making it more cumbersome and worsening its performance.

For convenience, the original NN to be protected will be called “first neural network”, and the modified and thus secured NN will be called “second neural network”. It should be noted that, as will be seen later, the 1^{st} NN may be secured a posteriori (once it has been learned), or from the outset (that is to say a secure version of the NN is learned directly).

In more detail, securing the first network as a second network consists in integrating, into its architecture, at least one convolutional neural network (CNN) approximating the identity function (this will be referred to as “Identity CNN” for convenience).

This “parasitic” CNN does not modify the operation of the NN, since its outputs are substantially equal to its inputs. On the other hand, it breaks up the original hyperplane structure.

The idea of approximating the identity function is highly original for a CNN, since it is an unnatural task that it has difficulty in accomplishing. To rephrase, it is always desirable for a CNN to perform semantically complex processing operations (such as for example image segmentation), and never a task as trivial as reproducing its own input.

In addition, as will be seen below, it is possible to insert multiple Identity CNNs into the 1^{st} NN, at various locations, involving certain channels, all chosen dynamically and randomly where appropriate, thereby leaving no chance for an attacker (it would take an unimaginable number of requests sent to the 2^{nd} NN to recover the original 1^{st} NN under the artificial hyperplanes).

### Method

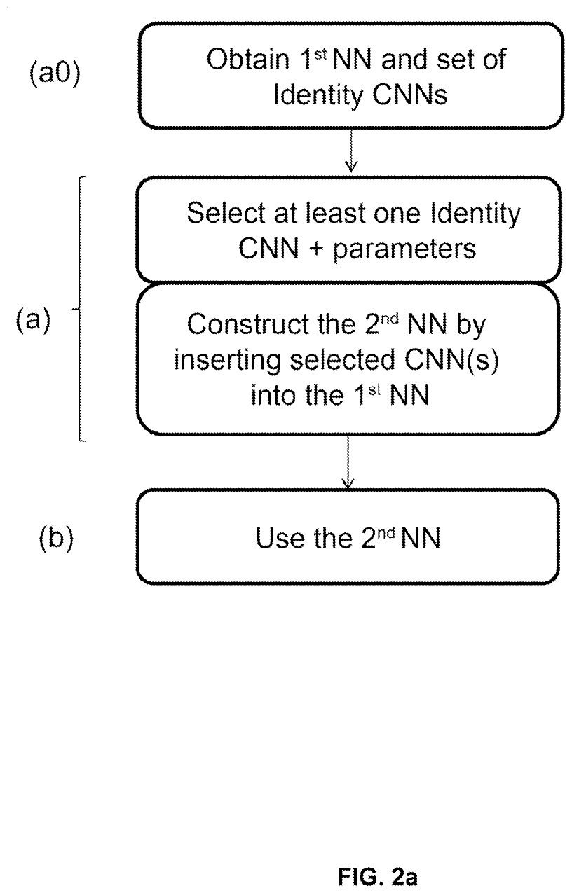

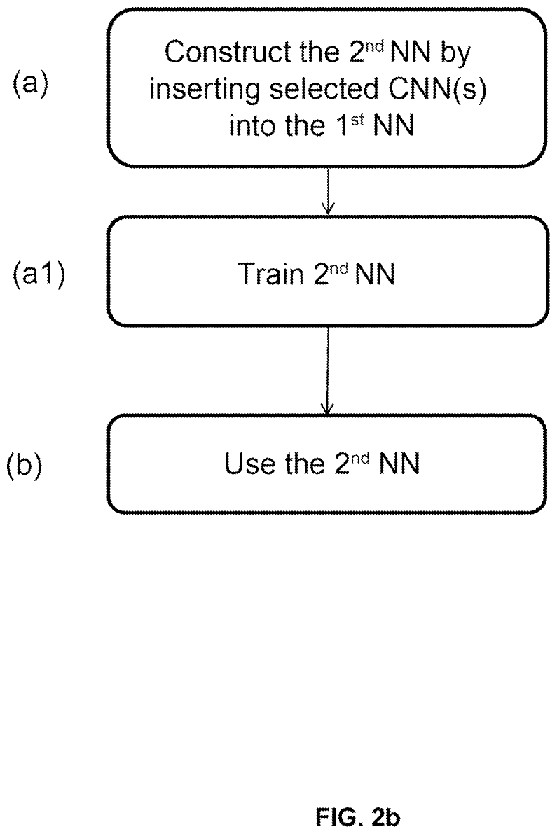

According to a first aspect, what is proposed, with reference to [FIG. 2a], is a first embodiment of the method for the secure use of the 1^{st} NN on an input datum, implemented by the data processing means 21 of the terminal 2.

The method advantageously begins with a “preparatory” step (a0) of obtaining parameters of the 1^{st} NN and of at least one Identity CNN, preferably a plurality of Identity CNNs, in particular of various architectures, of various input and output sizes, trained on different bases, etc., so as to define a set of Identity CNNs that is varied if possible; this will be seen in more detail later.

This step (a0) may be a step of training each of the networks on a dedicated learning base, in particular the 1^{st} NN, preferably implemented by the data processing means 11 of the server 1 for this purpose, but it will be understood that the networks (in particular the Identity CNNs) could be pre-existing and taken as they are. In any case, the one or more Identity CNNs may be trained in particular on any public image base, or even on random data (no need for them to be annotated as it is assumed that the input is also the expected output, possibly apart from noise, see below). One alternative embodiment in which there is no such step (a0) will be seen below.

Main step (a) comprises constructing said 2^{nd} NN corresponding to the 1^{st} NN, into which is inserted at least one convolutional neural network approximating the identity function, in particular one or more selected Identity CNNs. In other words, step (a) is a step of inserting the one or more Identity CNNs into the 1^{st} NN. If there are multiple selected Identity CNNs, they may be inserted one after the other.

To this end, step (a) advantageously comprises selecting one or more Identity CNNs from among said set of Identity CNNs, for example randomly. Other “insertion parameters” may be selected, in particular a position in the 1^{st} NN (target layer) and/or channels of a target layer of the 1^{st} NN, see below. In any case, it is still possible for the set of Identity CNNs to contain just one CNN, such that there is no need for selection, or even for the Identity CNN to be trained on the fly.

Insertion is understood to mean the addition of the layers of the Identity CNN upstream of the “target” layer of the 1^{st} NN, such that the input of this layer is at least partly the output of the Identity CNN. In other words, the Identity CNN “intercepts” all or part of the input of the target layer in order to replace it with its output.

It will be understood that, since the Identity CNN approximates the identity function, its outputs are substantially identical to its inputs, such that the data received by the target layer are substantially identical to those that are intercepted.

The target layer is preferably a linear layer (and not a non-linear layer with an activation function for example), such that the Identity CNN is inserted at the input of a linear layer of the 1^{st} NN.

The target layer is preferably a layer within the 1^{st} NN, that is to say a layer other than the first (between the second layer and the last). Particularly preferably, the target layer is thus a linear layer within the 1^{st} NN.

Advantageously, the Identity CNN has an output size smaller than an input size of said linear layer, so as to approximate only certain input channels of this linear layer (that is to say not all of them). Input/output size is understood to mean the number of input/output channels.

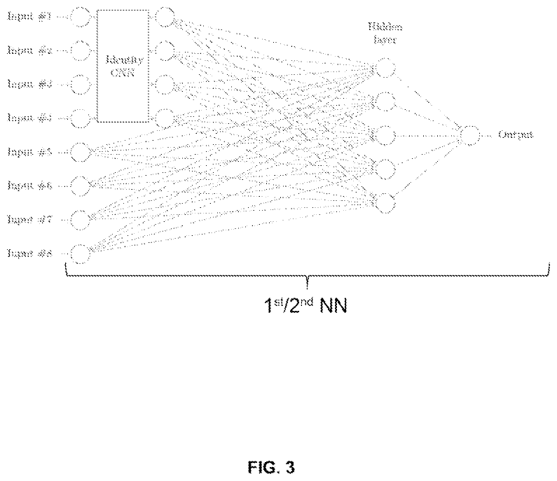

This is what is seen in the example of [FIG. 3], which shows a 1^{st} NN with three linear layers (including a central hidden layer), in which an Identity CNN is arranged at the input of the second layer.

It may be seen that the first layer has eight input channels (size 8), while the Identity CNN has only four input/output channels (by definition, a CNN approximating the identity function has the same input and output dimensions). Thus, of the eight input channels of the first linear layer, only four are approximated, and the other four are as they are. Acting on only some of the channels (that is to say not all of the neurons) has three advantages: the CNN is able to be smaller and therefore involve fewer computations when executed, acting only partially on a layer generates surprising disruptions for an attacker, and it is even possible to arrange multiple CNNs under a layer and thus further increase the disruptions of the hyperplanes for an attacker.

Step (a) may also comprise, as explained, selecting the target layer and/or the input channels of the target layer acted on by the Identity CNN (selected beforehand where applicable). For example, in FIG. 3, these are channels 1, 2, 3 and 4, but any set of four channels from among the eight, for example channels 1, 3, 5 and 7, could have been taken.

This selection may again be made randomly and dynamically, that is to say new channels are drawn for each new request to use the 1^{st} NN, but also in a sequence, or else based on contextual data, and in particular the input datum. The present invention will not be limited to any way of selecting in particular the target layer/the channels to be approximated/the one or more Identity CNNs, as long as there is an active choice from among multiple possibilities so as to add entropy in order to complicate the task even further fora possible attacker.

In practice, the selection may be made according to the following protocol (each step being optional—each choice may be random or predetermined):
1. a number of Identity CNNs to be inserted is chosen;
2. as many Identity CNNs as this number are drawn from the set of Identity CNNs (with or without being put back);
3. for each Identity CNN that is drawn, a target layer to be acted upon (that is to say at the input of which the CNN will be inserted) is chosen from among the layers (in particular linear and/or internal layers) of the 1^{st} NN;
4. for each Identity CNN that is drawn, the same number of input channels of the associated target layer as the number of input/output channels of this Identity CNN are chosen.

With regard to point 3., it should be noted that two Identity CNNs may be chosen to act on the same target layer: either the channels in question are separate and there is no problem, or at least one channel overlaps and, in this case, it may either be decided that it is undesirable (and the draw is restarted), or be accepted that one Identity CNN is upstream of the other: a channel may thus be approximated twice in a row before arriving at the input of the target layer.

With regard to point 4., it should be noted that Identity CNNs are typically networks working on images, that is to say two-dimensional objects (“rectangles”), and therefore having a number of input/output channels equal to the product of two integers, that is to say of the form a*b, where a and b are integers each greater than or equal to two, and even preferentially “squares” of dimension a². It is entirely possible to imagine using CNNs working on three-dimensional objects and therefore having a number of input/output channels equal to the product of three integers, that is to say of the form a*b*c, etc. In the example of FIG. 3, there is an Identity CNN working on 2×2 images, and therefore with four input/output channels.

Lastly, it should be noted that the selection and construction actions may be partially nested (and therefore implemented at the same time): if there are multiple Identity CNNs to be inserted, it is possible to determine the insertion parameters for the first one, insert it, determine the insertion parameters for the second one, insert it, etc. Additionally, as explained, the target layer and/or channels may be selected on the fly in step (a).

At the end of step (a), it is assumed that the 2^{nd} NN is constructed. Then, in a step (b), this 2^{nd} NN may be used on said input datum, that is to say the 2^{nd} NN is applied to the input datum and this gives an output datum that may be provided to the user of the terminal 2 without any risk of being able to lead back to the 1^{st} NN.

### Identity CNN

Small CNNs consisting only of an alternation of convolution layers (linear layers) and non-linear layers with an activation function such as ReLU give very good results both in terms of quality of approximation of the identity and in terms of complication of the hyperplanes without otherwise making the 1^{st} NN more cumbersome.

For example, the Identity CNN may comprise only two or three convolution layers (even though a limit will not be drawn to any architecture).

According to one particularly preferred embodiment, it is possible to take a square input/output Identity CNN of a size up to 16×16 with two or three filter convolution layers of a size 5×5.

It should be noted that each Identity CNN aims to approximate the identity as best possible, possibly apart from a small amount of noise. To this end, during learning, it is possible, as an alternative to using the input “as it is” as the expected output, to use the input plus noise, preferably centered Gaussian noise. The Applicant found that this worked particularly well (see the document A Protection against the Extraction of Neural Network Models, Hervé Chabanne, Vincent Despiegel, Linda Guiga, https://arxiv.org/pdf/2005.12782.pdf), and it is additionally also possible to add even more variability to the set of Identity CNNs by adding various noises.

Of course, it is possible, in all or part of the set of Identity CNNs, not to add any noise, that is to say to approximate the identity function as best possible.

### Tests

Tests were performed taking, as 1^{st} NN, a ReLU NN with three hidden layers of fully connected network (FCN) type, the hidden layers having respectively 512, 512 and 32 input channels, this FCN being used for the recognition of handwritten figures (classification of input images of any size). This 1^{st} NN may be trained for this task on the MNIST (Mixed National Institute of Standards and Technology) learning base, and then exhibits a correct classification rate of 97.9%

The abovementioned Identity CNN of an input size 16×16 (256 channels) may be trained on 10000 random images, and this gives an average absolute error between the input and the output of 0.0913%.

The insertion of this Identity CNN onto 256 of the 512 input channels of the first or second hidden layer of the 1^{st} NN exhibits no drop in the correct classification rate for the 2^{nd} NN.

### A Posteriori Learning

As an alternative to obtaining the parameters of the 1^{st} NN and of the one or more Identity CNNs beforehand, it is possible to start directly with step (a) of constructing the 2^{nd} NN from models of the 1^{st} NN and Identity CNN, where applicable by implementing the abovementioned selections to determine the architecture of the 2^{nd} NN, and only then to learn the parameters of the 2^{nd} NN on the learning base of the 1^{st} NN (for example the abovementioned NIST base). This is the embodiment illustrated by [FIG. 2b]; it will be understood that the construction and the learning are implemented this time on the side of the server 1.

This avoids having to learn the parameters of the Identity CNN separately, since its own parameters are learned automatically at the same time as those of the rest of the NN.

The results are equivalent; the only inconvenience is that it is not possible to dynamically “reconstruct” the 2^{nd} NN upon each request, since it would take too long to carry out the learning again each time.

Thus, according to a second aspect, the invention relates to a learning method for a second neural network, implemented by the data processing means 11 of the server 1, again comprising step (a) of constructing the second neural network corresponding to a first neural network, into which is inserted at least one convolutional neural network approximating the identity function; and then a step (a1) of learning the parameters of the second neural network from a public learning database.

In a third aspect of the invention, it is possible to use this learning method as part of a method for the secure use of a first neural network on an input datum (like the method according to the first aspect), by adding the same step (b) of using the 2^{nd} NN on said input datum (this time implemented by the data processing means 21 of the terminal 1), that is to say the 2^{nd} NN is applied to the input datum, and this gives an output datum that is able to be provided to the user of the terminal 2 without any risk of being able to lead back to the 1^{st} NN.

### Computer Program Product

According to a fourth and a fifth aspect, the invention relates to a computer program product comprising code instructions for executing (in particular on the data processing means 11, 21 of the server 1 or of the terminal 2) a method according to the first or the third aspect of the invention for the secure use of a first neural network on an input datum or a method according to the second aspect of the invention for learning parameters of a second neural network, and also storage means able to be read by a computer equipment (a memory 12, 22 of the server 1 or of the terminal 2) on which this computer program product is contained.

1. A method for the secure use of a first neural network on an input datum, the method comprising, by data processing circuitry of a terminal:
(a) constructing a second neural network corresponding to the first neural network, into which is inserted, at the input of a target layer within the first neural network, at least one convolutional neural network approximating identity function; and
(b) using the second neural network on said input datum.

2. The method as claimed in claim 1, wherein said convolutional neural network has an output size smaller than an input size of said target layer to approximate only certain input channels of this target layer.

3. The method as claimed in claim 1, wherein step (a) further comprises selecting said target layer of the first neural network from among the layers of said first neural network.

4. The method as claimed in claim 1, wherein step (a) further comprises selecting input channels of said target layer to be approximated from among all of the input channels of the target layer.

5. The method as claimed in claim 1, wherein the at least one convolutional neural network approximating the identity function has an output size equal to a product of two integers.

6. The method as claimed in claim 1, comprising a preliminary step (a0) of obtaining parameters of the first neural network and of the at least one convolutional neural network approximating the identity function.

7. The method as claimed in claim 6, wherein step (a0) further comprises obtaining parameters of a set of convolutional neural networks approximating the identity function, step (a) further comprising selecting, from said set, at least one convolutional neural network approximating the identity function to be inserted.

8. The method as claimed in claim 7, wherein step (a) further comprises, for each selected convolutional neural network approximating the identity function, selecting said target layer of the first neural network from among the layers of said first neural network and/or selecting the input channels of said target layer to be approximated from among all of the input channels of the target layer.

9. The method as claimed in claim 7, wherein step (a) further comprises selecting, beforehand, a number of convolutional neural networks approximating the identity function of said set to be selected.

10. The method as claimed in claim 6, wherein step (a0) is a step, implemented by data processing circuitry of a server, of learning the parameters of the first neural network and of the at least one convolutional neural network approximating the identity function from at least one learning database.

11. The method as claimed in claim 1, wherein the first neural network and the one or more convolutional neural networks approximating the identity function further comprise an alternation of linear layers and of non-linear layers with an activation function such as a ReLU function.

12. The method as claimed in claim 11, wherein said target layer is a linear layer.

13. The method as claimed in claim 11, wherein the at least one convolutional neural network approximating the identity function comprises two or three linear layers, which are filter convolutional layers, for example of a size 5×5.

14. A method for learning parameters of a second neural network, the method comprising, by data processing circuitry of a server:
(a) constructing the second neural network corresponding to a first neural network, into which is inserted, at an input of a target layer within the first neural network, at least one convolutional neural network approximating an identity function; and
(a1) learning the parameters of the second neural network from a learning database.

15. A method for the secure use of a first neural network on an input datum, the method comprising learning parameters of a second neural network in accordance with the method as claimed in claim 14; and implementation, by data processing circuitry of a terminal, of step (b) of using the second neural network on said input datum.

16. (canceled)

17. A non-transitory computer readable storage medium readable by a computer equipment on which a computer program product comprises code instructions for executing a method as claimed in claim 1 for learning parameters of a second neural network, or for the secure use of a first neural network on an input datum.

18. The method as claimed in claim 2, wherein step (a) further comprises selecting said target layer of the first neural network from among the layers of said first neural network.

19. The method as claimed in claim 2, wherein step (a) further comprises selecting input channels of said target layer to be approximated from among all of the input channels of the target layer.

20. The method as claimed in claim 3, wherein step (a) further comprises selecting input channels of said target layer to be approximated from among all of the input channels of the target layer.
